(19) United States
(12) Patent Application Publication
(10) Pub. No.: US 2017/0337544 A1
(43) Pub. Date: Nov. 23, 2017

(54) METHOD AND SYSTEM FOR MANAGING THE DISTRIBUTION OF AID OR BENEFITS INVOLVING MULTIPLE PARTNERS SHARING AN INFRASTRUCTURE

(71) Applicant: MasterCard International Incorporated, Purchase, NY (US)

(72) Inventors: Juan Carlos Leonardo WILEY GARCIA, Ossining, NY (US); Bensam JOYSON, Singapore (SG); Hao TANG, Singapore (SG); Jiaming LI, Singapore (SG); Donghao HUANG, Singapore (SG); Tobias PUEHSE, Singapore (SG); Sasha KAPADIA, New York, NY (US); Alexandre LIEGE, New York, NY (US); David Anthony ROBERTS, Warrington (GB)

(73) Assignee: MasterCard International Incorporated, Purchase, NY (US)

(21) Appl. No.: 15/160,272

(22) Filed: May 20, 2016

(51) Int. Cl. G06Q 20/34; G06F 17/30; G06Q 20/40; G06Q 50/26

(52) U.S. Cl. CPC G06Q 20/3572; G06Q 50/26; G06F 17/30867; G06F 17/30876; G06Q 20/4014

(57) ABSTRACT

A method for managing programs associated with multiple entities on a payment card includes: storing lease profiles, each lease profile including a lease identifier, managing identifier, transaction account numbers, and one or more tenant identifiers; receiving a management request, the management request including a specific lease identifier, specific managing identifier, and requesting tenant identifier; identifying a specific lease profile that includes the specific lease identifier; verifying that the specific managing identifier corresponds to the managing identifier included in the specific lease profile; inserting the requesting tenant identifier into the specific lease profile; receiving a program request, the request including the specific lease identifier, the requesting tenant identifier, and program data; and transmitting the program data to a payment card corresponding to one of the transaction account numbers included in the specific lease profile.

### FIELD

The present disclosure relates to the providing of commodities and other aid benefits for multiple partners, specifically the use of an integrated circuit card to enable multiple non-governmental organizations to provide commodities and other aid benefits to recipients via a single card for receipt through offline transactions.

### BACKGROUND

Aid programs are used throughout the world to provide benefits to those in need. Aid programs may provide a wide array of benefits to their recipients, such as disaster relief, medical assistance, food, tools, clothing, and more. Organizations that provide commodities of some kind, such as food, seeds, water, shoes, school supplies, etc. are often interested in limiting the number of commodities that are provided to recipients to help ensure that every person in need is able to receive assistance. In many cases, such programs are implemented using means that are not reliant on, or are limited in their reliance on, technology, such as due to a lack of technological infrastructure in the area due to remoteness, turmoil, recent disaster, etc., often which may be a basis for the aid response.

One method of implementation for a commodity disbursement program that many aid organizations utilize is a voucher system. In such a system, vouchers are provided to recipients that can be redeemed for commodities through the aid organization. The organization is able to limit the total number of vouchers, limit the number of vouchers provided to each recipient, and control what commodities each voucher may be redeemed for, as a way of ensuring supply and providing each recipient with an opportunity to receive aid. However, vouchers are often susceptible to being lost, destroyed, stolen, or counterfeited, which can result in commodities and other benefits being provided to unintended recipients and supplies being exhausted before all intended recipients can be aided.

In an effort to mitigate some of the negative effects of voucher systems, some programs have been developed to utilize payment cards as a replacement for vouchers, such as the MasterCard Aid Network. In such a system, a prepaid payment card is used, where the prepaid amount is stored on the payment card and may be used to purchase the commodities or other benefits in an offline payment transaction, with the payment being reflected in the prepaid balance on the card. Such a system may be a useful alternative to vouchers, as a single card may be provided to each recipient by an organization without the need for the recipient to keep track of multiple vouchers. In addition, additional aid may be provided via increasing the balance of the prepaid card, instead of having to issue new vouchers.

However, current systems that utilize payment cards for disbursing aid benefits are often limited. For example, in current systems, each aid organization issues its own card to recipients. As a result, a recipient that may receive aid from multiple organizations, as may often be the case in many situations where aid is being provided, may receive several different cards from several different organizations, which may be difficult for the recipient to keep track of. In addition, current systems often utilize currency, such as a fiat currency or a point-based alternative currency, that can be redeemed by a recipient for commodities based on values assigned to the respective commodities. In such a system, the aid organization may be unable to control the spending of the recipient, such as to ensure that some recipients do not buy out a specific commodity and leaving it unavailable to others, or to ensure that recipients purchase a suitable amount of a needed commodity, such as ensuring that mothers of infants and toddlers have access to formula and other needed items. In such systems, the aid organization's only method of control may be issuing a separate card for each commodity they want to control, thus negating the benefits of using a payment card over vouchers.

Thus, there is a need for a technological solution to enable aid organizations to provide benefits to recipients via the use of integrated circuit payment cards that are not limited in terms of the programs being provided to the recipients and in a way that enables the aid organizations to control the disbursement of commodities. Such a solution may result in greater access to commodities for those in need, and greater convenience and efficiency for both aid organizations and their recipients, which may greatly increase the aid that is provided.

### SUMMARY

The present disclosure provides a description of systems and methods for managing programs associated with multiple entities on a payment card. Leases may be associated with groups of payment cards, where a managing organization may provide access to leases to multiple aid organizations, enabling for each aid organization to provide program data for inclusion on the associated payment cards. As a result, payment cards may be issued to recipients that can be used to receive benefits for multiple aid programs that are managed by multiple entities, increasing the aid that may be provided to recipients while also greatly increasing recipient convenience and disbursement efficiency.

A method for managing programs associated with multiple entities on a payment card includes: storing, in a lease database of a processing server, a plurality of lease profiles, wherein each lease profile includes at least a lease identifier, a managing identifier, a plurality of transaction account numbers, and one or more tenant identifiers; receiving, by a receiving device of the processing server, a management request, wherein the management request includes at least a specific lease identifier, a specific managing identifier, and a requesting tenant identifier; executing, by a querying module of the processing server, a first query on the lease database to identify a specific lease profile where the included lease identifier corresponds to the specific lease identifier; verifying, by a verification module of the processing server, that the specific managing identifier corresponds to the managing identifier included in the specific lease profile; executing, by the querying module of the processing server, a second query on the lease database to insert the requesting tenant identifier into the specific lease profile; receiving, by the receiving device of the processing server, a program request, wherein the program request includes at least the specific lease identifier, the requesting tenant identifier, and program data; and electronically transmitting, by a transmitting device of the processing server, the program data to a payment card corresponding to one of the plurality of transaction account numbers included in the specific lease profile.

A system for managing programs associated with multiple entities on a payment card includes: a transmitting device of a processing server; a lease database of the processing server configured to store a plurality of lease profiles, wherein each lease profile includes at least a lease identifier, a managing identifier, a plurality of transaction account numbers, and one or more tenant identifiers; a receiving device of the processing server, a management request, wherein the management request includes at least a specific lease identifier, a specific managing identifier, and a requesting tenant identifier; a querying module of the processing server configured to execute a first query on the lease database to identify a specific lease profile where the included lease identifier corresponds to the specific lease identifier; and a verification module of the processing server configured to verify that the specific managing identifier corresponds to the managing identifier included in the specific lease profile. The querying module of the processing server is further configured to execute a second query on the lease database to insert the requesting tenant identifier into the specific lease profile. The receiving device of the processing server is further configured to receive a program request, wherein the program request includes at least the specific lease identifier, the requesting tenant identifier, and program data. The transmitting device of the processing server is further configured to electronically transmit the program data to a payment card corresponding to one of the plurality of transaction account numbers included in the specific lease profile.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for conducting offline, commodity-based transactions using payment cards having multiple entity programs for disbursement of aid benefits in accordance with exemplary embodiments.

FIG. 2 is a block diagram illustrating the processing server of FIG. 1 for the management of leases of program data for multiple entities associated with a payment card in accordance with exemplary embodiments.

FIG. 3 is a block diagram illustrating the payment card of FIG. 1 for the processing of offline, commodity-based transactions in accordance with exemplary embodiments.

FIG. 4 is a flow diagram illustrating a process for managing a lease for program data from multiple tenant entities for provisioning to payment cards in accordance with exemplary embodiments.

FIGS. 5A and 5B are flow diagrams illustrating a process for conducting an offline, commodity-based transaction for disbursing aid benefits in accordance with exemplary embodiments.

FIG. 6 is a flow diagram illustrating a process for the conducting of a commodity-based transaction and updating of data in a payment card based thereon in accordance with exemplary embodiments.

FIG. 7 is a flow chart illustrating an exemplary method for managing programs associated with multiple entities on a payment card in accordance with exemplary embodiments.

FIG. 8 is a flow chart illustrating an exemplary method for conducting an offline, commodity-based transaction in accordance with exemplary embodiments.

FIG. 9 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Transaction Account—A financial account that may be used to fund a transaction, such as a checking account, savings account, credit account, virtual payment account, etc. In some cases, the account may be a non-financial account, such as if a non-fiat currency is used as an alternative to a fiat currency, such as a point-based alternative currency. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Card—A card or data associated with a transaction account that may be provided to a merchant in order to conduct a financial or non-financial transaction via the associated transaction account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated transaction account (e.g., as stored in a communication device, such as a smart phone or computer). For example, in some instances, data including a payment account number may be considered a payment card for the processing of a transaction funded by the associated transaction account. In some instances, a check or electronic voucher may be considered a payment card where applicable.

Point of Sale—A computing device or computing system configured to receive interaction with a user (e.g., a consumer, employee, etc.) for entering in transaction data, payment data, and/or other suitable types of data for the purchase of and/or payment for goods and/or services. The point of sale may be a physical device (e.g., a cash register, kiosk, desktop computer, smart phone, tablet computer, etc.) in a physical location that a customer visits as part of the transaction, such as in a “brick and mortar” store, or may be virtual in e-commerce environments, such as online retailers receiving communications from customers over a network such as the Internet. In instances where the point of sale may be virtual, the computing device operated by the user to initiate the transaction or the computing system that receives data as a result of the transaction may be considered the point of sale, as applicable.

### System for Disbursement of Aid Benefits

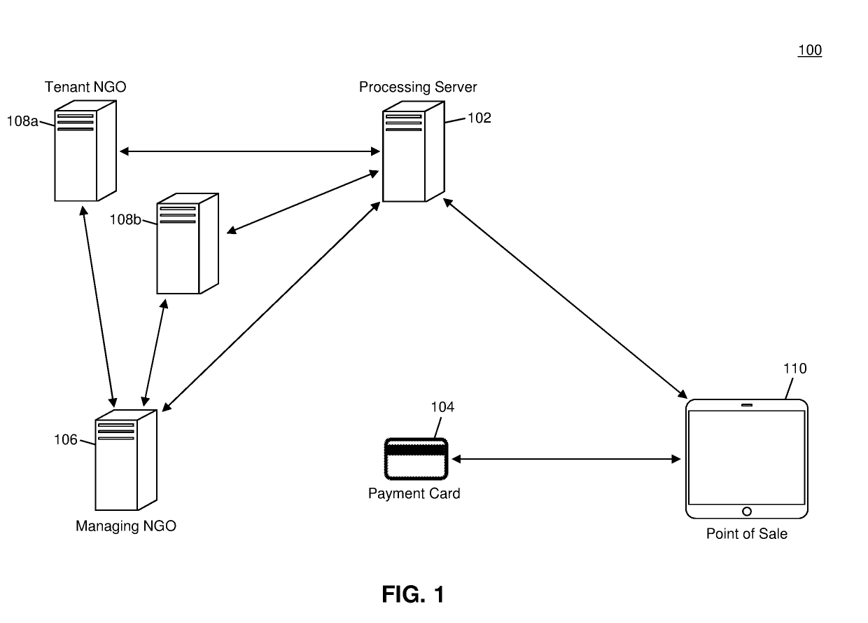

FIG. 1 illustrates a system 100 for the disbursement of aid benefits to recipients via payment cards that are associated with multiple entity programs and configured for offline, commodity-based transactions.

The system 100 may include a processing server 102. The processing server 102, discussed in more detail below, may be configured to manage leases associated with payment cards 104 for the provisioning of programs thereto for use in conducting payment transactions for the disbursement of aid benefits. The processing server 102 may provide a platform to entities for the management of leases that are associated with payment cards 104 including the setting of permissions regarding entities authorized to provision programs to the associated payment cards as well as additional management functions generally associated with payment cards, such as the deactivation, reissuance, adjustment of data, etc., thereof. In some embodiments, payment cards 104 used in the system 100 may be integrated circuit cards, which may include integrated circuits having suitable memory for storing the program data for programs provisioned to the payment card 104 based on its associated lease.

The system 100 may include a managing non-governmental organization (NGO) 106. The managing NGO 106 may be an NGO or other authorized organization (e.g., a government, multilateral organization, etc.) that may manage leases associated with payment cards 104 that are used to organize the provisioning of programs to the respective payment cards 104 for the disbursement of aid benefits to the recipients thereof. In some embodiments, the managing NGO 106 may not have any programs loaded on the payment card 104 and may operate solely in a managerial capacity. In other embodiments, the managing NGO 106 may operate as a manager with respect to leases associated with payment cards 104 and may also operate as a tenant NGO 108 to one or more of the managed leases.

Tenant NGOs 108, such as the tenant NGOs 108a and 108b illustrated in the system 100 of FIG. 1, may be NGOs that provision program data to payment cards 104 for programs used in the disbursement of aid benefits to recipients of the respective payment cards 104. In some instances, a tenant NGO 108 may also be a managing NGO 106 for a lease for which they are a tenant, or may be a managing NGO 106 for one or more other leases for which they are not a tenant. In some cases, aid benefits provided by a tenant NGO 108 may be unrelated to aid benefits or objectives of a managing NGO 106. In other cases, tenant NGO 108 aid benefits may be directly associated with aid benefits or objectives of the managing NGO 106 for leases to which the tenant NGOs 108 are assigned.

In the system 100, a managing NGO 106 may be assigned as a manager for one or more leases via the platform provided by the processing server 102. Processes for the registration of a managing NGO 106 as a manager for leases will be apparent to persons having skill in the relevant art. Each lease may be associated with a plurality of payment cards 104. In exemplary embodiments, each payment card 104 may be associated with only a single lease. The managing NGO 106 may then be able to manage each lease to which they are manager via the processing server 102. Management functions may be access by, for example, a web page hosted by or on behalf of the processing server 102, an application program associated with the processing server 102, an application programming interface (API) configured to interface with the processing server 102, or other suitable method.

As part of the management of a lease, the managing NGO 106 may assign a plurality of tenant NGOs 108 as tenants to the lease. Assigning of tenant NGOs 108 may include electronically transmitting, to the processing server 102, a management request that includes at least a lease identifier, a management identifier, and a plurality of tenant identifiers. The lease identifier may be a unique value associated with the lease for identification and management thereof, such as an identification number. The management identifier may be a unique value associated with the managing NGO 106 for identification thereof, which may be used by the processing server 102 to ensure that the proper managing NGO 106 is attempting management of the indicate lease. In some cases, the management request may also include authentication credentials associated with the managing NGO 106 for authentication thereof, such as a password, cryptogram, biometric data associated with an authorized user, etc. In some embodiments, the managing NGO 106 may limit the number of tenants that may be added to a lease and/or the number of programs that one or more of the tenants may add to associated payment cards.

The plurality of tenant identifiers may be unique values associated with tenant NGOs 108 that are being assigned to the indicated lease, used in the identification thereof. Tenant identifiers may include identification numbers or other suitable types of values. In some cases, the plurality of tenant identifiers may be associated with tenant NGOs 108 already registered with the processing server 102 (e.g., via a separate registration process). In other cases, one or more tenant identifiers may be associated with unregistered tenant NGOs 108. In such a case, the tenant identifier may be accompanied with registration data for registration of the associated tenant NGO 108, where the registration data may include, for example, authentication data. In some such cases, the associated tenant NGO 108 may register with the processing server 102 subsequently to access functions associated with the assigned lease. In such instances, the processing server 102 may provide the managing NGO 106 with additional data for providing to the associated tenant NGO 108 as proof of identity, such as a one-time password or other data value that may be used to authenticate the tenant NGO 108 as the tenant NGO 108 indicated in the management request.

The processing server 102 may receive the management request and, if applicable, may authenticate the managing NGO 106 as authorized to manage the indicated lease. If authorized, the processing server 102 may then update the lease by assigning the tenant NGOs 108 associated with the plurality of tenant identifiers to the lease. The assignment of a tenant NGO 108 to a lease may include the adding of the corresponding tenant identifier to a lease profile associated with the lease, which may be stored in the processing server 102, such as discussed in more detail below.

Once a tenant NGO 108 has been assigned to a lease, the tenant NGO 108 may be able to manage one or more programs for provisioning to payment cards 104 associated with the lease. The tenant NGO 108 may electronically transmit a program request to the processing server 102 that may include their tenant identifier, the lease identifier, and program data for a program to be provisioned to the associated payment cards 104. In some instances, the program request may also include authentication information associated with the tenant NGO 108 for authentication thereof. The program data may include data associated with a program to be provisioned to the payment cards 104 associated with the lease for use in the disbursement of aid benefits to a recipient thereof.

Program data may include at least a program identifier, the tenant identifier associated with the tenant NGO 108 to which the program corresponds, and data used in aid disbursement. The data used in aid disbursement, discussed in more detail below, may include a point balance and/or a plurality of commodity codes and corresponding commodity balances. The program data may also include any additional data used in the management of the program on the payment cards 104 to which it is provisioned, such as individual data associated with the respective payment card 104 (e.g., an identification value), a program name, point value data, etc.

Once program data has been received for a program, the processing server 102 may provision the program data to each of the payment cards 104 associated with a lease to which the program has been associated. Methods for provisioning data to a payment card 104 will be apparent to persons having skill in the relevant art. In some embodiments, the processing server 102 may provision program data to a payment card 104 upon receipt of the program data. In other embodiments, the processing server 102 may wait until program data has been received for a plurality of the programs assigned to a lease prior to provisioning of the program data for each of the programs to the payment card 104. For example, in some instances, the processing server 102 may wait until the program data has been received for all programs associated with a lease prior to provisioning of the program data to associated payment cards 104.

Upon provisioning, a payment card 104 may thus store program data for each of a plurality of programs associated with the corresponding lease. The program data for each of the programs may include the program identifier and tenant identifier associated therewith for identification and management thereof. In some embodiments, a single tenant NGO 108 may provision more than one program to its associated leases. In such an embodiment, a payment card 104 associated with one of the leases may store program data for two or more programs having the same tenant identifier, but may include different program identifiers for identification thereof. In some instances, the number of programs associated with a single tenant NGO 108 may be limited by the managing NGO 106 associated with the lease.

Once loaded with the program data, the payment card 104 may be distributed to a recipient to which the corresponding aid benefits are to be provided. The recipient may then use the payment card 104 to receive the corresponding aid benefits. The recipient may take the payment card 104 to a point of sale 110 for the purchase of commodities and other aid benefits. The point of sale 110 and payment card 104 may conduct a transaction that may utilize a program stored on the payment card 104 for the processing thereof. In exemplary embodiments, payment transactions conducted via the point of sale 110 and payment card 104 may be offline transactions, such that the payment transaction may be performed without communication by the point of sale 110 or payment card 104 to an additional entity, such as a traditional payment network or financial institution.

To initiate the payment transaction, the payment card 104 and point of sale 110 may establish a communication channel. In some embodiments, the communication channel may be established via a physical interface, such as the insertion of the payment card 104 into a receiving device of the point of sale 110 configured to read data from the payment card 104 via one or more contact points. In other embodiments, the communication channel may be a non-physical interface, such as a wireless communication channel established via near field communication or other suitable communication method. The payment card 104 may provide program data to the point of sale 110 via the interface, which may include at least the program identifier for each of the programs stored on the payment card 104.

The point of sale 110 may receive the program identifiers and may determine which program it would like to utilize for the transaction. The determination may be based on a number of criteria. One such criterion may include programs stored locally on the point of sale 110. For example, the point of sale 110 may only be configured for transactions with a portion of the programs assigned to the payment card 104, such as instances where the point of sale 110 may be associated with a tenant NGO 108 and usable for only its aid programs. Other criteria may include a selection of the recipient. For instance, the point of sale 110 may display programs stored on the payment card 104 that the point of sale 110 is configured for use, and the recipient of the payment card 104 may select, via a suitable input device of the point of sale 110, the program for which they would like to receive aid. For example, the point of sale 110 may be a tablet computer and may display an icon associated with each aid program through which the recipient may transact, and the recipient may touch the icon for the program that they would like to receive benefits for.

Once the program has been selected, the point of sale 110 may communicate the program identifier to the payment card 104 via the established communication channel. The payment card 104 may then identify program data for the selected program in its internal memory and communicate some or all of the program data back to the point of sale 110. For example, the payment card 104 may provide point and/or commodity balances to the point of sale 110 for the program. The point of sale 110 may then display options for selection by the recipient for commodities or other benefits for receipt via the aid program. For instance, if the program is a point-based program, the point of sale 110 may display benefits available for receipt and corresponding point values, as well as indicating to the recipient their point balance. The recipient may then select the benefits they wish to purchase with their points.

For commodity-based programs, the point of sale 110 may display the commodities for which there is an available commodity balance, as indicated in the program data provided by the payment card 104. The recipient may select a number of each commodity they wish to receive, up to the commodity's respective balance. For example, the payment card 104 may indicate an available balance for five different commodities, where the recipient may be presented with a selection of each of five commodities on the point of sale 110. The recipient may then select how many, if any, of each of the five commodities they would like to receive. After making the selection, the point of sale 110 may electronically transmit the selected amounts and the commodity codes for the corresponding commodities back to the payment card 104. The payment card 104 may then update the commodity balances for the program to reflect the disbursement of the benefits to the recipient. In some instances, the payment transaction may not be completed until the payment card 104 confirms the availability of the selected commodities. In such an instance, the payment card 104 may confirm that the selected amount of each commodity is available, and may return a confirmation message to the point of sale 110. In cases where the payment card 104 determines that the selected commodities are not available, then the payment card 104 may return a denial message to the point of sale 110, and the recipient may be prevented from receiving the selected commodities, but may be provided an opportunity to repeat the transaction with a new selection.

In commodity-based programs, each commodity may be associated with a commodity code, which may be a unique value suitable for use in the identification of the associated commodity. In some instances, a type of commodity may have multiple commodity codes, which may represent different versions of that commodity. For instance, an aid program for the disbursement of food may provide milk and rice to recipients, which may be provided in various sizes. In such an instance, there may be multiple commodity codes for both rice and milk, with each commodity code being associated with a different portion size, such as commodity codes for 1 quart of milk, 1 gallon of milk, a 1 pound bag of rice, and a 5 pound bag of rice. In some cases, a program may use the lowest available denomination for a commodity and may reflect the balance accordingly. For example, 5 pound bags of rice may be available for disbursement, the balance for which may be reflected as a five 1 pound bags of rice.

In some cases, an aid program may use a combination of points and commodity balances. In some such cases, the recipient may be provided with an option to use either an available commodity balance or points for an overall purchase or for a given commodity in a purchase. In other such cases, the recipient may make their selection, and the payment card 104 may first decrement the available commodity balances based on the selections and may then deduct the point balance for the program based on point values for each of the selected commodities for which the available balance is exceeded. A combined program may be useful, for instance, in cases where an aid program may want to ensure that each recipient receives a suitable amount of a number of specified commodities, but provide the recipient with freedom to select additional amounts of desired commodities.

The recipient may then continue to use the payment card 104 for payment transactions to receive aid benefits for each of the programs that have been provisioned to their payment card 104. The use of multiple programs on the payment card 104 may enable the recipient to receive aid benefits for a plurality of different programs via the use of a single payment card 104, without having to possess and keep track of a number of different payment cards. In addition, the use of leases managed via the processing server 102 may enable tenant NGOs 108 to easily provision their programs to payment cards 104 without having to manage or bear the cost of the payment cards 104 themselves. This may also be useful in instances where a tenant NGO 108 may lack the infrastructure or technology to use and distribute payment cards 104 for benefit disbursement, but may use the benefits provided by the managing NGO 106 and processing server 102 to provide aid to recipients they may otherwise be unable to reach. Furthermore, the management of the payment cards 104 by the managing NGO 106 may enable the managing NGO 106 to control the tenants that are assigned to payment cards 104 and the use thereof, which may provide for more efficient and controlled aid disbursement.

For example, in some embodiments, the managing NGO 106 may use demographics or other data for the organization of payment cards 104 and leases, which may be used to determine leases to which a tenant NGO 108 should be assigned based on their aid program. For instance, the managing NGO 106 may manage leases for different categories of recipients, such as a lease for individuals in need of both food and medical assistance, a lease for individuals in need of food but not medical assistance, a lease for families in need of both food and medical assistance, and a lease for families in need of food but not medical assistance. A tenant NGO 108 may have an aid program that focuses on commodities and benefits related to child healthcare, such as infant formula, child medicines, doctor consultations, etc. The tenant NGO 108 may contact the managing NGO 106, which may assign them to the lease for families in need of food and medical assistance. The tenant NGO 108 can provide their program to the processing server 102, which may provision it to the appropriate payment cards 104, such that the tenant NGO's program will reach their desired audience of families that are in need of medical assistance. The tenant NGO 108 may thus easily reach their desired audience without the need to even identify suitable recipients or distribute payment cards 104, vouchers, or other tools needed for the recipients to receive the disbursement. For instance, this may be applicable in a refugee camp or similar situation where a large number of individuals may receive humanitarian aid from several different NGOs.

The managing NGO 106 may be able to do the same for a plurality of different tenant NGOs 108, which may thus enable all of the tenant NGOs 108 to reach their desired recipients, and ensure that recipients each receive their necessary aid benefits via a single payment card, via the simplified processing provided using the processing server 102. In some embodiments, the processing server 102 may also be configured to provide updated program data to payment cards 104 and receive updated data from program cards 104 after provisioning for further management thereof, which may further increase the efficiency and effectiveness of the system 100. In such an embodiment, the processing server 102 may be configured to provision updated program data and receive program data when a payment card 104 is connected to a point of sale 110 that is connected to the processing server 102, such as via a traditional payment network. In other such embodiments, the processing server 102 may provide updated program data to a point of sale 110 for a specified lease, identified via the corresponding lease identifier. The point of sale 110 may then, if a payment card 104 having the same lease identifier is interfaced therewith, push the updated program data to the payment card 104. Such processes may be used to enable the updating of payment cards 104 through offline means.

### Processing Server

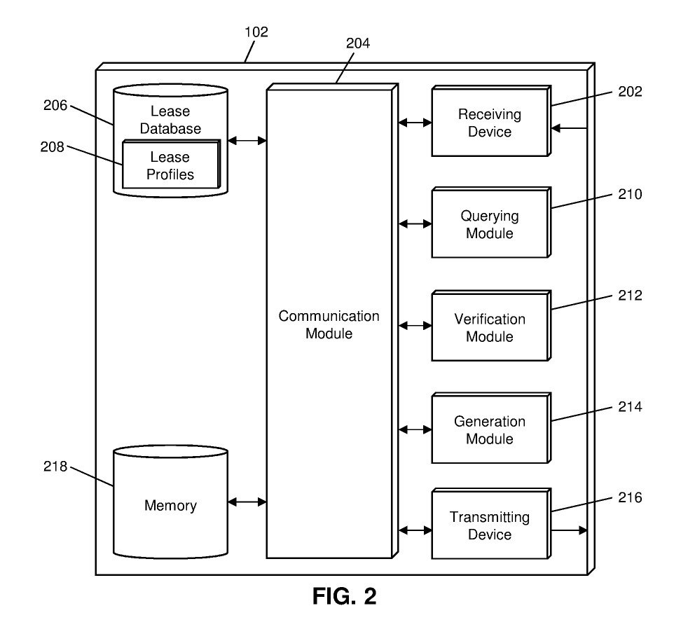

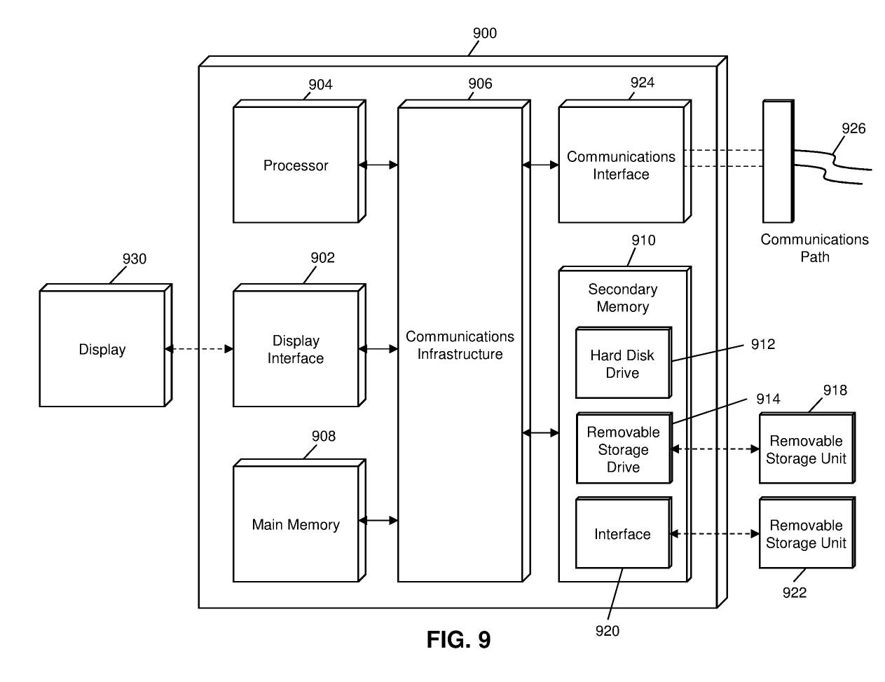

FIG. 2 illustrates an embodiment of a processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 900 illustrated in FIG. 9 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over payment rails, such as using specially configured infrastructure associated with payment networks for the transmission of transaction messages that include sensitive financial data and information. In some instances, the receiving device 202 may also be configured to receive data from managing NGOs 106, tenant NGOs 108, points of sale 110, payment cards 104, and other entities via alternative networks, such as the Internet or physical communication interfaces. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by managing NGOs 106 and tenant NGOs 108 that may be superimposed or otherwise encoded with data used in the management of leases and program data associated with payment cards 104. Data signals may be electronically transmitted via web pages, application programs, APIs, or other suitable interfaces, and may be superimposed or otherwise encoded with management requests, program requests, update requests, etc., used in performing the functions discussed herein. The receiving device 202 may also be configured to receive data signals electronically transmitted from points of sale 110, such as may be superimposed or otherwise encoded with program data and/or update data read from payment card 104. For instance, points of sale 110 may provide program data that includes updated commodity balances for a payment card 104, such as may be used by the related tenant NGO 108 in management of their aid program. In some instances, the receiving device 202 may also be configured to receive data signals electronically transmitted by payment cards 104 via a suitable interface, such as may be superimposed or otherwise encoded with program data.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 210, verification module 212, generation module 214, etc. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include a lease database 206. The lease database 206 may be configured to store a plurality of lease profiles 208 using a suitable data storage format and schema. The lease database 206 may be a relational database that utilizes structured query language for the storage, identification, modifying, updating, accessing, etc. of structured data sets stored therein. Each lease profile 208 may be a structured data set configured to store data related to a lease. A lease profile 208 may include at least a lease identifier, a managing identifier, a plurality of transaction account numbers, and one or more tenant identifiers. The lease identifier may be a unique value associated with the related lease. The managing identifier may be a unique value associated with the managing NGO 106 that is authorized to manage the related lease. In some instances, a lease profile 208 may also include authentication information associated with the managing NGO 106 for authentication thereof. The plurality of transaction account numbers may include transaction account numbers associated with each payment card 104 to which the related lease corresponds. The one or more tenant identifiers may include unique values associated with tenant NGOs 108 assigned to the related lease. In some instances, a lease profile 208 may also include authentication for each of the tenant NGOs 108 assigned to the related lease. In some embodiments, a lease profile 208 may also include program data for the programs to be provisioned to the related payment cards 104. In some cases, the program data may include data associated with each individual related payment card 104. In some cases, a lease profile 208 may also include a maximum number of tenant NGOs 108 that may be assigned to the related lease and/or a maximum number of programs that may be assigned to the related lease, either overall or on a per-tenant NGO 108 basis.

The processing server 102 may include a querying module 210. The querying module 210 may be configured to execute queries on databases to identify information. The querying module 210 may receive one or more data values or query strings, and may execute a query string based thereon on an indicated database, such as the lease database 206, to identify information stored therein. The querying module 210 may then output the identified information to an appropriate engine or module of the processing server 102 as necessary. The querying module 210 may, for example, execute a query on the lease database 206 to identify a lease profile for which a management, program, or other data request is received via the lease identifier included therein. In another example, the querying module 210 may execute a query on memory 218 of the processing server 102 to identify an entity profile associated with an NGO, such as for registration or management thereof.

The processing server 102 may also include a verification module 212. The verification module 212 may be configured to receive data to be verified as input, may attempt verification of the data, and may output a result of the verification to another module or engine of the processing server 102. The verification module 212 may be configured to verify managing identifiers and tenant identifiers included in received data requests as corresponding to authorized entities for management of a lease identifier included in the data request, such as based on data stored in a corresponding lease profile 208 (e.g., identified via the querying module 210). The verification module 212 may also be configured to perform authentication as part of the verification, such as by comparing authentication information provided in a data request with authentication information stored in the corresponding lease profile 208 or an entity profile associated with the corresponding entity.

The processing server 102 may also include a generation module 214. The generation module 214 may be configured to generate data signals, data requests, and other data for use in performing the functions of the processing server 102 as discussed herein. The generation module 214 may receive an instruction, may generate data as specified in the instruction, and may output the generated data to another module or engine of the processing server 102. For example, the generation module 214 may be configured to generate lease, tenant, and managing identifiers, may generate data signals for transmission to managing NGOs 106 and tenant NGOs 108 for the management of lease and program data, etc.

The processing server 102 may also include a transmitting device 216. The transmitting device 216 may be configured to transmit data over one or more networks via one or more network protocols. In some embodiments, the transmitting device 216 may be configured to transmit data over the payment rails, such as using specially configured infrastructure associated with payment networks for the transmission of transaction messages that include sensitive financial data and information, such as identified payment credentials. In some instances, the transmitting device 216 may be configured to transmit data to payment cards 104, managing NGOs 106, tenant NGOs 108, points of sale 110, and other entities via alternative networks, such as the Internet, physical interfaces, etc. In some embodiments, the transmitting device 216 may be comprised of multiple devices, such as different transmitting devices for transmitting data over different networks, such as a first transmitting device for transmitting data over the payment rails and a second transmitting device for transmitting data over the Internet. The transmitting device 216 may electronically transmit data signals that have data superimposed that may be parsed by a receiving computing device. In some instances, the transmitting device 216 may include one or more modules for superimposing, encoding, or otherwise formatting data into data signals suitable for transmission.

The transmitting device 216 may be configured to electronically transmit data signals to managing NGOs 106 and tenant NGOs 108 that are superimposed or otherwise encoded with data used in the management of leases and program data. The transmitting device 216 may also be configured to provision program data to payment cards 104. The provisioning of program data may use electronically transmitted data signals that may be transmitted via a communication network or physical interface directly to the payment card 104 for storage therein, or via an intermediate entity and/or system configured to load the program data on the payment card 104, such as the point of sale 110. The transmitting device 216 may be configured to electronically transmit data signals to a point of sale 110 superimposed or otherwise encoded with update data for updating program data or other data of a payment card 104.

The processing server 102 may also include a memory 218. The memory 218 may be configured to store data for use by the processing server 102 in performing the functions discussed herein. The memory 218 may be configured to store data using suitable data formatting methods and schema and may be any suitable type of memory, such as read-only memory, random access memory, etc. The memory 218 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 218 may be comprised of or may otherwise include a relational database that utilizes structured query language for the storage, identification, modifying, updating, accessing, etc. of structured data sets stored therein.

### Payment Card

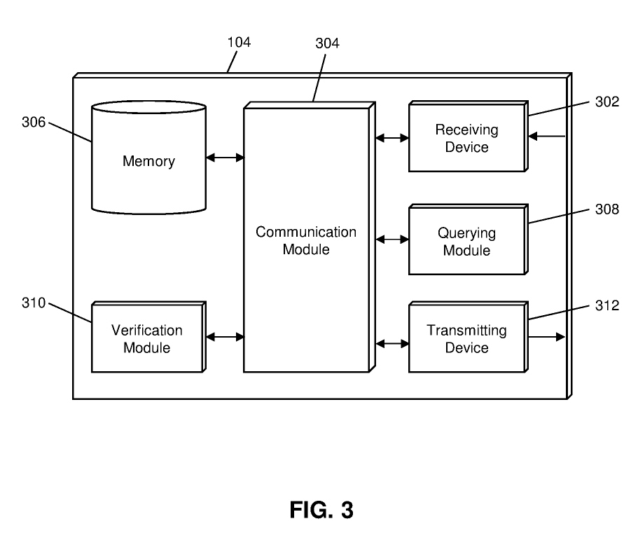

FIG. 3 illustrates an embodiment of a payment card 104 of the system 100. It will be apparent to persons having skill in the relevant art that the embodiment of the payment card 104 illustrated in FIG. 3 is provided as illustration only and may not be exhaustive to all possible configurations of the payment card 104 suitable for performing the functions as discussed herein. For example, the computer system 900 illustrated in FIG. 9 and discussed in more detail below may be a suitable configuration of the payment card 104.

The payment card 104 may include a receiving device 302. The receiving device 302 may be configured to receive data over one or more networks via one or more network protocols. In some embodiments, the receiving device 302 may be configured to receive data over a physical interface, such as via one or more contact points located on the payment card 104. In some instances, the receiving device 302 may also be configured to receive data from the processing server 102, points of sale 110, and other entities via alternative networks, such as near field communication, Bluetooth, radio frequency, etc. In some embodiments, the receiving device 302 may be comprised of multiple devices, such as different receiving devices for receiving data over different networks, such as a first receiving device for receiving data over a physical interface and a second receiving device for receiving data via near field communication. The receiving device 202 may receive electronically transmitted data signals, where data may be superimposed or otherwise encoded on the data signal and decoded, parsed, read, or otherwise obtained via receipt of the data signal by the receiving device 302. In some instances, the receiving device 302 may include a parsing module for parsing the received data signal to obtain the data superimposed thereon. For example, the receiving device 302 may include a parser program configured to receive and transform the received data signal into usable input for the functions performed by the processing device to carry out the methods and systems described herein.

The receiving device 302 may be configured to receive data signals electronically transmitted by the processing server 102 and/or point of sale 110, which may be superimposed or otherwise encoded with program data for storage in the payment card 104. The receiving device 302 may also be configured to receive data signals electronically by points of sale 110 that may be superimposed or otherwise encoded with data messages used in the processing of a payment transaction, such as may include requests for program identifiers, requests for program data, transaction data, etc.

The payment card 104 may also include a communication module 304. The communication module 304 may be configured to transmit data between modules, engines, databases, memories, and other components of the payment card 104 for use in performing the functions discussed herein. The communication module 304 may be comprised of one or more communication types and utilize various communication methods for communications within a computing device. For example, the communication module 304 may be comprised of a bus, contact pin connectors, wires, etc. In some embodiments, the communication module 304 may also be configured to communicate between internal components of the payment card 104 and external components of the payment card 104, such as externally connected databases, display devices, input devices, etc. The payment card 104 may also include a processing device. The processing device may be configured to perform the functions of the payment card 104 discussed herein as will be apparent to persons having skill in the relevant art. In some embodiments, the processing device may include and/or be comprised of a plurality of engines and/or modules specially configured to perform one or more functions of the processing device, such as a querying module 308, verification module 310, etc. As used herein, the term “module” may be software or hardware particularly programmed to receive an input, perform one or more processes using the input, and provide an output. The input, output, and processes performed by various modules will be apparent to one skilled in the art based upon the present disclosure.

The payment card 104 may also include a memory 306. The memory 306 may be configured to store data for use by the payment card 104 in performing the functions discussed herein. The memory 306 may be configured to store data using suitable data formatting methods and schema and may be any suitable type of memory, such as read-only memory, random access memory, etc. The memory 306 may include, for example, encryption keys and algorithms, communication protocols and standards, data formatting standards and protocols, program code for modules and application programs of the processing device, and other data that may be suitable for use by the payment card 104 in the performance of the functions disclosed herein as will be apparent to persons having skill in the relevant art. In some embodiments, the memory 306 may be comprised of or may otherwise include a relational database that utilizes structured query language for the storage, identification, modifying, updating, accessing, etc. of structured data sets stored therein.

The memory 306 may be configured to store program data for each of a plurality of different programs provisioned to the payment card 104 (e.g., and received via the receiving device 302). Program data may include at least a program identifier, tenant identifier, and data for use in aid disbursement. The data for use in aid disbursement may include a point balance, commodity codes, associated point balances and/or commodity balances, and other suitable data, such as rules for the conversion of points to or from commodities and an order of decrement for point and commodity balances. The memory 306 may also be configured to store additional data related to the payment card 104, such as a lease identifier, transaction account number, etc.

The payment card 104 may include a querying module 308. The querying module 308 may be configured to execute queries on databases to identify information. The querying module 308 may receive one or more data values or query strings, and may execute a query string based thereon on an indicated database, such as the memory 306, to identify information stored therein. The querying module 308 may then output the identified information to an appropriate engine or module of the payment card 104 as necessary. The querying module 308 may, for example, execute a query on the memory 306 to identify program identifiers stored in program data included therein for providing to a point of sale 110, a query to identify a point balance and commodity balances and corresponding commodity codes included in program data associated with a specified program identifier, a query to update commodity and/or point balances for a program with a specified program identifier, etc.

The payment card 104 may also include a verification module 310. The verification module 310 may be configured to receive data to be verified as input, may attempt verification of the data, and may output a result of the verification to another module or engine of the payment card 104. The verification module 310 may be configured to verify point balances and/or commodity balances for a payment transaction attempted using the payment card 104, such as based on transaction data received by the receiving device 302 from the point of sale 110. In some instances, the verification module 310 may also be configured to verify updated program data. For instance, a point of sale 110 may transmit updated program data to the payment card 104, which may be verified prior to updating of the memory 306, such as to verify authenticity of the program data or to verify that the updated program data has not been previously applied.

The payment card 104 may also include a transmitting device 312. The transmitting device 312 may be configured to transmit data over one or more networks via one or more network protocols. In some embodiments, the transmitting device 312 may be configured to transmit data over a physical interface, such as via contact points included on the payment card 104. In some instances, the transmitting device 312 may be configured to transmit data to the processing server 102, points of sale 110, and other entities via alternative networks, such as near field communication, Bluetooth, radio frequency, etc. In some embodiments, the transmitting device 312 may be comprised of multiple devices, such as different transmitting devices for transmitting data over different networks, such as a first transmitting device for transmitting data over the physical interface and a second transmitting device for transmitting data over near field communication. The transmitting device 312 may electronically transmit data signals that have data superimposed that may be parsed by a receiving computing device. In some instances, the transmitting device 312 may include one or more modules for superimposing, encoding, or otherwise formatting data into data signals suitable for transmission.

The transmitting device 312 may be configured to electronically transmit data signals to points of sale 110 that are superimposed or otherwise encoded with payment card data and/or program data, such as a transaction account number, program identifier, tenant identifier, lease identifier, point balance, commodity codes and corresponding commodity balances and/or point values, etc. In some instances, the transmitting device 312 may be configured to electronically transmit data signals to processing servers 102 or points of sale 110 that may be superimposed or otherwise encoded with program data for use in updating data associated with the payment card 104, such as for inventory or aid disbursement tracking.

### Process for Provisioning of Multiple Entity Programs to a Payment Card

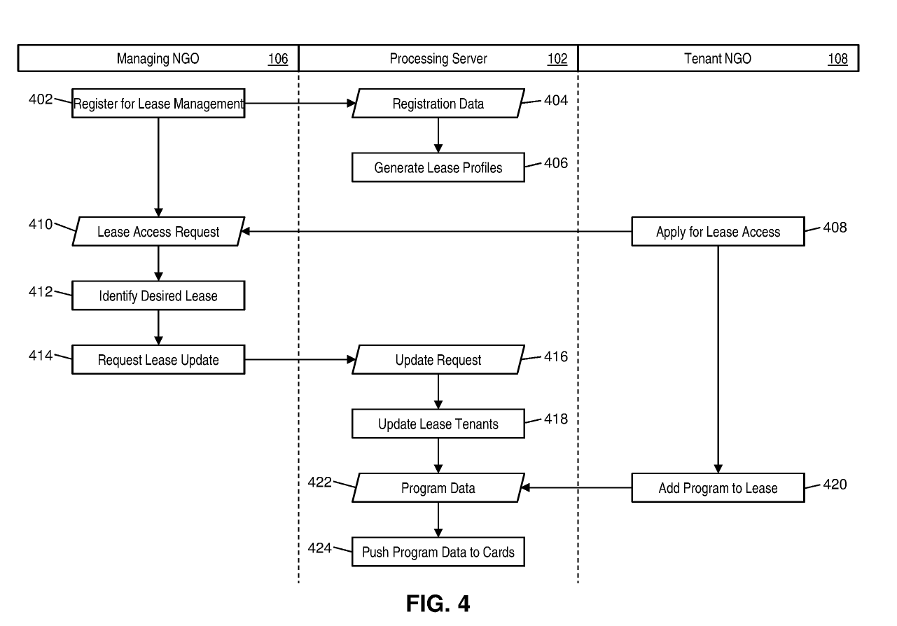

FIG. 4 illustrates a process for the provisioning of one of a plurality of programs associated with multiple tenant NGOs 108 to a payment card 104 for the disbursement of aid benefits to a recipient.

In step 402, the managing NGO 106 may register with the processing server 102 for management of a lease, which may include electronically transmitting a data signal to the processing server 102 via a suitable communication method, such as an API associated with the processing server 102, which is superimposed or otherwise encoded with registration data. In step 404, the receiving device 202 of the processing server 102 may receive the registration data. The registration data may include a managing identifier associated with the managing NGO 106, such as a username, email address, identification number, etc., and, in some instances, may also include authentication information. In some cases, a managing NGO 106 may register once for management of multiple leases. In some instances, the registration data may include data associated with leases to be managed, such as a maximum number of tenant NGOs 108, a maximum number of programs to be added to the lease, etc.

In step 406, the querying module 210 of the processing server 102 may execute a query on the lease database 206 of the processing server 102 to generate a new lease profile 208 for each of the leases being applied for by the managing NGO 106. Each lease profile 208 may include at least the managing identifier and a lease identifier, such as may be generated by the generation module 214 of the processing server 102 or the querying module 210 during generation of the respective lease profile 208.

In step 408, a tenant NGO 108 wanting access to at least one of the leases registered by the managing NGO 106 may electronically transmit a data signal to the managing NGO 106, either directly or via the processing server 102, that is superimposed or otherwise encoded with a lease access request. The lease access request may include a tenant identifier associated with the tenant NGO 108, which may have been previously registered with the processing server 102, as well as the lease identifier for the desired lease or data indicating the tenant NGO's desired recipients. In step 410, the managing NGO 106 may receive the lease access request and, in step 412, may identify the lease desired by the tenant NGO 108. In instances where the tenant NGO 108 may provide a lease identifier, the desired lease may be identified thereby. In instances where the tenant NGO 108 may provide data indicating their desired recipients, the managing NGO 106 may identify a lease where corresponding payment cards 104 are to be distributed to the desired recipients. In some instances, the managing NGO 106 may identify that creation of a new lease may be suitable for serving the tenant NGO 108.

In step 414, the managing NGO 106 may electronically transmit a data signal to the processing server 102 that is superimposed or otherwise encoded with a request for a lease update. In step 416, the receiving device 202 of the processing server 102 may receive the request. The request may include at least the lease identifier for the lease being updated (e.g., or for the lease to be created, if applicable), the managing identifier associated with the managing NGO 106, the tenant identifier associated with the tenant NGO 108, and, if applicable, authentication credentials associated with the managing NGO 106. In step 418, the querying module 210 of the processing server 102 may execute a query on the lease database 206 to update the lease profile 208 that includes the specified lease identifier to include the tenant NGO's tenant identifier.

In step 420, the tenant NGO 108 may electronically transmit a data signal to the processing server 102 that is superimposed or otherwise encoded with program data for a program to be added to the lease. In step 422, the receiving device 202 of the processing server 102 may receive the program data. The program data may also be accompanied by the tenant identifier associated with the tenant NGO 108, the lease identifier associated with the lease or leases to which the program data is to be added, and, if applicable, authentication credentials associated with the tenant NGO 108. The program data may include a program identifier, the tenant identifier, and any additional data used in management and use of the program, such as point balances, point values, commodity codes, commodity balances, etc. In step 424, the transmitting device 216 of the processing server 102 may provision the program data to the payment cards 104 associated with the specified lease. In some embodiments, the adding of the program may be subject to a limit placed on the lease by the managing NGO 106 on the number of programs a tenant NGO 108 may add to the lease.

### Process for Conducting an Offline, Commodity-Based Transaction

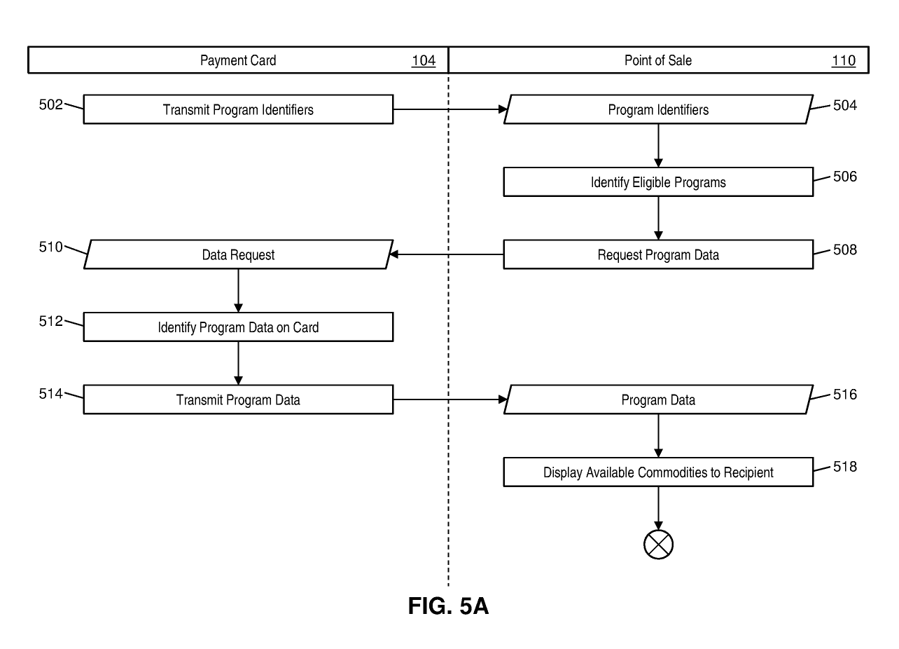

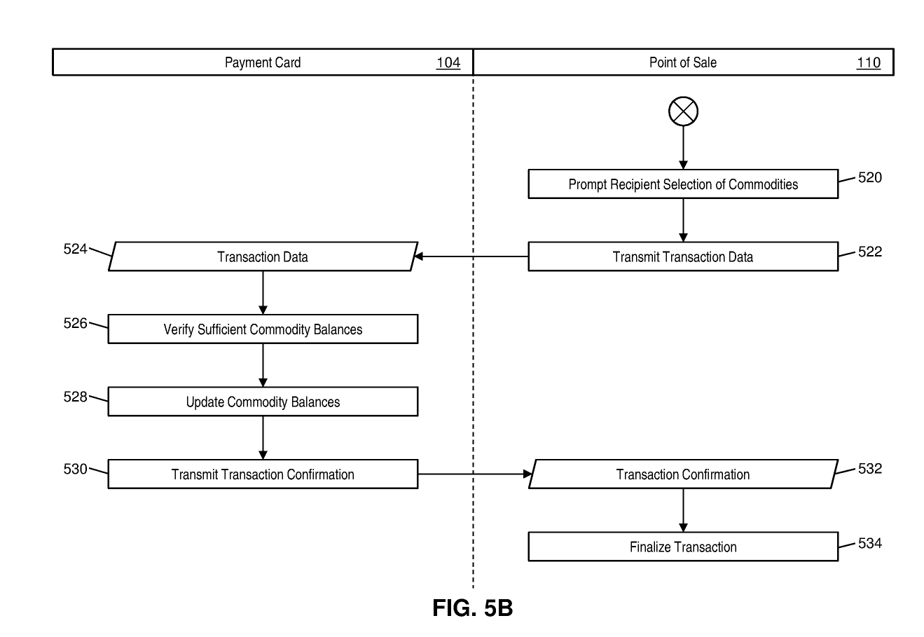

FIGS. 5A and 5B illustrate a process for the conducting of an offline, commodity-based transaction for the disbursement of aid benefits via a payment card 104 that is loaded with one or more programs associated with one or more tenant NGOs 108 that provide the associated aid benefits.

In step 502, the transmitting device 312 of a payment card 104 may electronically transmit a data signal superimposed with program identifiers for each of the programs stored in the memory 306 thereof to a point of sale 110 via a suitable interface, such as a physical interface or near field communication. In step 504, the point of sale 110 may receive the program identifiers for each of the programs. In step 506, the point of sale 110 may identify eligible programs. Eligible programs may be programs for which the point of sale 110 is configured to provide assistance for aid disbursement via the processing of payment transactions. Eligible programs may be identified, for instance, via a list of eligible programs stored in the point of sale 110 and comparison of corresponding program identifiers to those provided by the payment card 104. In some instances, the point of sale 110 may display eligible programs on a display device, where one or more programs may be selected (e.g., by the recipient), with their associated program identifiers being selected as the eligible programs.

The program identifiers for the eligible programs may be included a request for program data, which may be electronically transmitted by the point of sale 110 to the payment card 104. In step 510, the receiving device 302 of the payment card 104 may receive the data request, which includes at least one of the program identifiers that had been provided to the point of sale 110. In step 512, the querying module 308 of the payment card 104 may execute a query on the memory 306 included therein to identify the program data for each of the programs for which a program identifier as received in the data request from the point of sale 110. In step 514, the transmitting device 314 of the payment card 104 may electronically transmit a data signal back to the point of sale 110 superimposed or otherwise encoded with the identified program data.

In step 516, the point of sale 110 may receive the program data for each of the identified eligible programs. The program data may include at least the program identifier for the associated program and one or more pairs of commodity codes and corresponding commodity balances, and, in some instances, may further include a point balance. In step 518, the point of sale 110 may prompt, via a display device and/or any other suitable output devices (e.g., emission of an audio signal via speakers), the recipient to select one or more commodities for purchase. In some instances, the display may indicate the available balance for each of the commodities. In some cases, the display device may only display commodities for which there is an available balance. In some embodiments, the display device may dynamically update the display as the recipient selects commodities, such as by updating the remaining balance, calculating point costs based on point values, remove or add commodities for purchase based on changes to available point balance, etc. The recipient may respond to the prompt by selecting one or more commodities or other benefits for purchase.

In step 522, the point of sale may electronically transmit transaction data for the payment transaction back to the payment card 104 via the interface. In step 524, the receiving device 302 of the payment card 104 may receive the transaction data. The transaction data may include at least one or more commodity codes and an associated purchase amount corresponding to the selections made by the recipient. In instances where points may also be used for the purchase, the transaction data may also include a point cost and/or commodity codes and associated purchase amounts for purchases made via points in addition to the commodity balance purchases. In step 526, the verification module 310 of the payment card 104 may verify that the program data for the selected program has sufficient commodity balances, and, if applicable, a point balance, for the selected purchase based on the transaction data.

In step 528, the querying module 308 of the payment card 104 may execute a query on the memory 306 to update the commodity balances for each of the purchased commodities in the program's program data, and, if applicable, also update the point balance. In instances where the transaction data may not include a point total for point-based purchases, step 528 may include calculation of the amount of points spent via the purchased based on stored commodity point cost data. In step 530, the transmitting device 312 of the payment card 104 may electronically transmit a transaction confirmation to the point of sale 110. In step 532, the point of sale 110 may receive the transaction confirmation, which may indicate that the transaction is confirmed as approved and successful, following the verification and updating of the commodity balances in the payment card 104. In step 534, the transaction may be finalized, such as by indication on the point of sale 110 and the disbursement of the purchased commodities to the recipient.

### Process for Commodity-Based Transactions via Payment Card

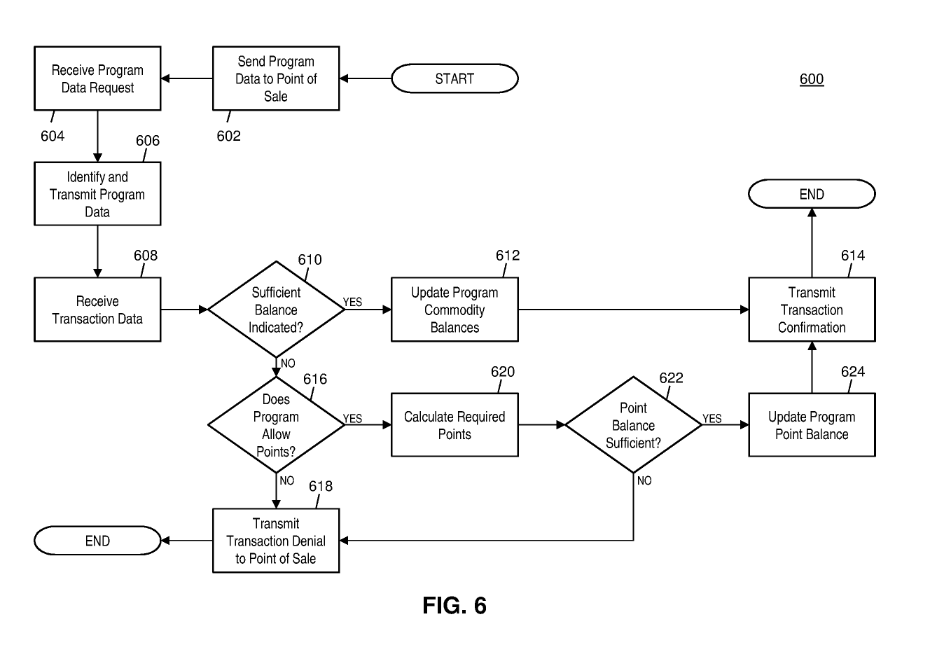

FIG. 6 illustrates a process 600 conducted via the payment card 104 for the processing of commodity-based transactions for the disbursement of aid benefits to a recipient associated therewith.

In step 602, the transmitting device 312 of the payment card 104 may electronically transmit a data signal to a point of sale 110 that is superimposed or otherwise encoded with program identifiers for each program stored therein. In some instances, the payment card 104 may also provide additional data to the point of sale 110, such as the lease identifier, tenant identifier for each program, managing identifier for the managing NGO 106, etc. In step 604, the receiving device 302 of the payment card may receive a program data request from the point of sale 110. The program data request may include a program identifier for which program data is being requested for a transaction.

In step 606, the querying module 308 of the payment card 104 may execute a query on the memory 306 to identify the program data associated with the program identifier included in the program data request, and the transmitting device 312 may electronically transmit a data signal back to the point of sale 110 that is superimposed or otherwise encoded with the program data. The program data may include at least one or more commodity codes and corresponding balances, and, if applicable, may also include a point balance. In step 608, the receiving device 302 of the payment card 104 may receive transaction data from the point of sale 110. The transaction data may include at least one or more commodity codes for selected commodities and associated selected amounts.

In step 610, the verification module 310 of the payment card 104 may determine if the payment card 104 has a sufficient balance for each of the indicated commodities. The determination may be based on the selected amounts included in the transaction data and the available balance for each of the respective commodity codes in the program data for the program as stored in the memory 306 (e.g., and identified via the querying module 308). If there is a sufficient balance, then, in step 612, the querying module 308 may execute a query on the memory 306 to update the commodity balances in the program data by decrementing them by the corresponding selected amounts. Then, in step 614, the transmitting device 312 may electronically transmit a transaction confirmation to the point of sale 110, indicating that the transaction is confirmed and may be finalized.

If, in step 610, the verification module 310 determines that there is not a sufficient commodity balance for at least one of the selected commodities, then, in step 616, the verification module 310 may determine if the program allows for the use of points in place of commodity balances. The determination may be based on the program data for the program as stored in the memory 306. For instance, there may be rules included in the program data, or the determination may be based on the inclusion or exclusion of a data field storing a point balance in the program data. If the verification module 310 determines that the program does not allow points, then, in step 618, the transmitting device 312 may electronically transmit a transaction denial to the point of sale 110, which may indicate that the transaction is denied due to the lack of available commodity balances, such that the commodities will not be disbursed to the recipient.

If the verification module 310 determines that the program does allow points, then, in step 620, the payment card 104 may calculate the number of points required to cover the additional commodities for which the respective commodity balances are exceeded. The number of points may be based on the number of commodities over the commodity balance are selected via their selected amounts as well as a point cost for each commodity, as may be stored in the program data for the selected program. In step 622, the verification module 310 may determine if the point balance for the selected program is sufficient to cover the calculated, required number of points. If the point balance is insufficient, then the process 600 may proceed to step 618 where the transaction denial may be electronically transmitted to the point of sale 110.

If the point balance is sufficient, then, in step 624, the querying module 308 of the payment card 104 may execute a query on the memory 306 to update the point balance by deducted the calculated number of points. In instances where a combination of commodity balances and points are used (e.g., a commodity balance was available and points used for a number of commodities selected that exceeds the available balance), the query may also update the corresponding commodity balances. The process 600 may then proceed to step 614, where the transaction may be confirmed for finalization.

Exemplary Method for Managing Programs Associated with Multiple Entities

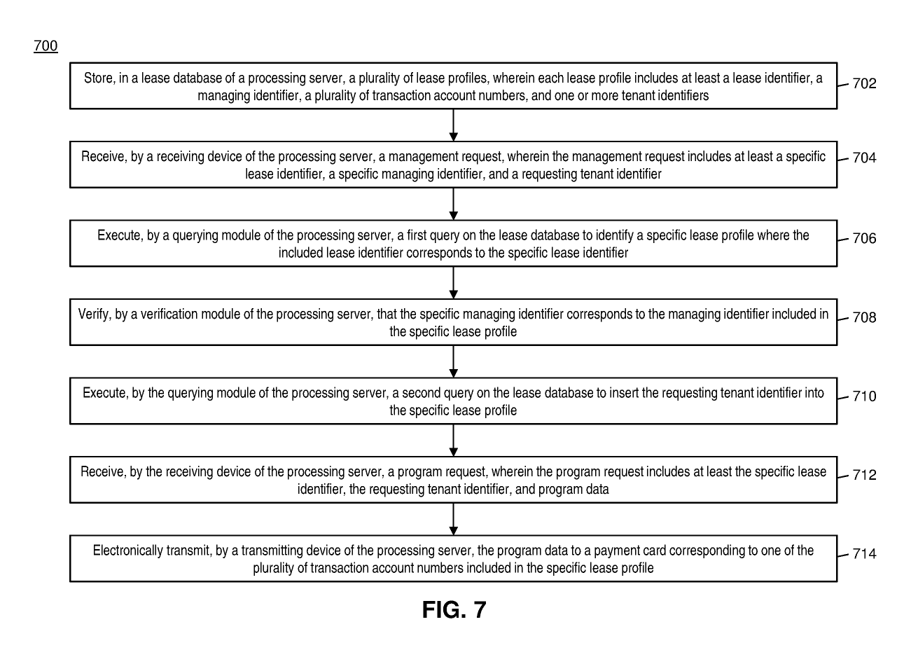

FIG. 7 illustrates a method 700 for the managing of programs on a payment card 104 that are associated with multiple entities via the use of leases for the disbursement of aid benefits to recipients.

In step 702, a plurality of lease profiles (e.g., lease profiles 208) may be stored in a lease database (e.g., the lease database 206) of a processing server (e.g., the processing server 102), wherein each lease profile includes at least a lease identifier, a managing identifier, a plurality of transaction account numbers, and one or more tenant identifiers. In step 704, a management request may be received by a receiving device (e.g., the receiving device 202) of the processing server, wherein the management request includes at least a specific lease identifier, a specific managing identifier, and a requesting tenant identifier.

In step 706, a first query may be executed on the lease database by a querying module (e.g., the querying module 210) of the processing server to identify a specific lease profile where the included lease identifier corresponds to the specific lease identifier. In step 708, a verification module (e.g., verification module 212) of the processing server may verify that the specific managing identifier corresponds to the managing identifier included in the specific lease profile.

In step 710, a second query may be executed on the lease database by the querying module of the processing server to insert the requesting tenant identifier into the specific lease profile. In step 712, a program request may be received by the receiving device of the processing server, wherein the program request includes at least the specific lease identifier, the requesting tenant identifier, and program data. In step 714, the program data may be electronically transmitted by a transmitting device (e.g., the transmitting device 216) of the processing server to a payment card (e.g., the payment card 104) corresponding to the plurality of transaction account numbers included in the specific lease profile.

In one embodiment, each lease profile may further include managing credentials associated with the managing identifier, the management request may further include authentication credentials, and verifying that the specific managing identifier corresponds to the managing identifier included in the specific lease profile may further include verifying that the authentication credentials correspond to the managing credentials included in the specific lease profile. In some embodiments, the payment card may include an embedded integrated circuit

In one embodiment, the management request may further include tenant credentials, execution of the second query may further insert the tenant credentials into the specific lease profile, the program request may further include authentication credentials, and the authentication credential may correspond to the tenant credentials inserted into the specific lease profile. In a further embodiment, the method 700 may also include verifying, by the verification module of the processing server, that the authentication credentials correspond to the tenant credentials inserted into the specific lease profile.

In some embodiments, the method 700 may further include storing, in a memory (e.g., the memory 306) of the payment card, the program data. In a further embodiment, the memory may further include additional program data associated with one or more additional programs, each additional program being associated with a tenant identifier of the one or more tenant identifiers included in the specific lease profile. In one embodiment, the program data may include at least one of: a program identifier, the requesting tenant identifier, a point balance, a plurality of commodity codes, and a plurality of commodity balances.

In some embodiments, execution of the first query on the lease database may insert the specific lease profile as a new lease profile. In some embodiments, the method 700 may also include executing, by the querying module of the processing server, a third query on the lease database to insert the program data in the specific profile identifier.

### Exemplary Method for Conducting an Offline, Commodity-Based Transaction

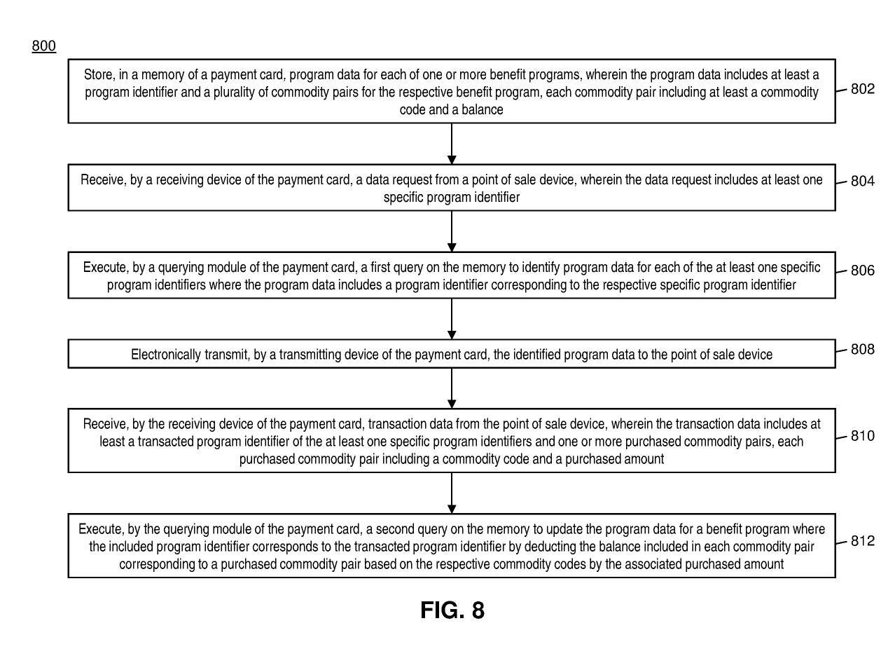

FIG. 8 illustrates a method 800 for the conducting of an offline, commodity-based transaction for the purchase of one or more commodities with exclusive balances via a payment card for the disbursement of aid benefits to an associated recipient.

In step 802, program data for each of one or more benefit programs may be stored in a memory (e.g., the memory 306) of a payment card (e.g., the payment card 104), wherein the program data includes at least a program identifier and a plurality of commodity pairs for the respective benefit program, each commodity pair including at least a commodity code and a balance. In step 804, a data request may be received by a receiving device (e.g., the receiving device 302) of the payment card from a point of sale device (e.g., the point of sale 110), wherein the data request includes at least one specific program identifier.

In step 806, a first query may be executed on the memory by a querying module (e.g., the querying module 308) of the payment card to identify program data for each of the at least one specific program identifiers where the program data includes a program identifier corresponding to the respective specific program identifier. In step 808, the identified program data may be electronically transmitted by a transmitting device (e.g., the transmitting device 216) of the payment card to the point of sale device.

In step 810, transaction data may be received by the receiving device of the payment card from the point of sale device, wherein the transaction data includes at least a transacted program identifier of the at least one specific program identifiers and one or more purchased commodity pairs, each purchased commodity pair including a commodity code and a purchased amount. In step 812, a second query may be executed on the memory by the querying module of the payment card to update the program data for a benefit program where the included program identifier corresponds to the transacted program identifier by deducting the balance included in each commodity pair corresponding to a purchased commodity pair based on the respective commodity codes by the associated purchased amount.

In one embodiment, the method 800 may further include: verifying, by a verification module (e.g., the verification module 310) of the payment card, that the balance included in each commodity pair corresponding to a purchased commodity pair based on the respective commodity codes is greater than or equal to the associated purchased amount; and electronically transmitting, by the transmitting device of the payment card, a transaction confirmation to the point of sale device indicating a result of the verification. In some embodiments, the program data may further include a tenant identifier associated with an entity configured to manage the associated program data. In a further embodiment, the one or more benefit programs may comprise at least two benefit programs, and the program data for each of the at least two benefit programs may include different tenant identifiers associated with different entities.

In one embodiment, the memory may further include a lease identifier. In some embodiments, the program data may further include a point balance. In a further embodiment, each commodity pair may include a point amount, and if the balance included in a commodity pair corresponding to a purchased commodity pair based on the respective commodity codes is less than the associated purchased amount, updating the program data may include deducting, from the point balance, an amount based on the point amount included in the commodity pair and a difference between the balance and the purchased amount. In another further embodiment, the transaction data may further include a point amount, and updating the program data may include updating the included point balance based on the point amount.

In one embodiment, the payment card may be an integrated circuit card. In a further embodiment, the memory, querying module, receiving device, and transmitting device are each included in the integrated circuit.

### Computer System Architecture

FIG. 9 illustrates a computer system 900 in which embodiments of the present disclosure, or portions thereof, may be implemented as computer-readable code. For example, the processing server 102 and payment card 104 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, 5A, 5B, 6, and 7.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device specifically configured to perform the functions discussed herein. The processor device 904 may be connected to a communications infrastructure 906, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive or universal serial bus port, the removable storage unit 918 may be a floppy disk or portable flash drive, respectively. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

The computer system 900 may further include a display interface 902. The display interface 902 may be configured to allow data to be transferred between the computer system 900 and external display 930. Exemplary display interfaces 902 may include high-definition multimedia interface (HDMI), digital visual interface (DVI), video graphics array (VGA), etc. The display 930 may be any suitable type of display for displaying data transmitted via the display interface 902 of the computer system 900, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 908 and secondary memory 910, which may be memory semiconductors (e.g., DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 3, 4, 5A, 5B, 6, and 7, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

The processor device 904 may comprise one or more modules or engines configured to perform the functions of the computer system 900. Each of the modules or engines may be implemented using hardware and, in some instances, may also utilize software, such as corresponding to program code and/or programs stored in the main memory 908 or secondary memory 910. In such instances, program code may be compiled by the processor device 904 (e.g., by a compiling module or engine) prior to execution by the hardware of the computer system 900. For example, the program code may be source code written in a programming language that is translated into a lower level language, such as assembly language or machine code, for execution by the processor device 904 and/or any additional hardware components of the computer system 900. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 900 to perform the functions disclosed herein. It will be apparent to persons having skill in the relevant art that such processes result in the computer system 900 being a specially configured computer system 900 uniquely programmed to perform the functions discussed above.

Techniques consistent with the present disclosure provide, among other features, systems and methods for managing programs associated with multiple entities on a payment card and use thereof in conducting offline, commodity-based transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for managing programs associated with multiple entities on a payment card, comprising:
storing, in a lease database of a processing server, a plurality of lease profiles, wherein each lease profile includes at least a lease identifier, a managing identifier, a plurality of transaction account numbers, and one or more tenant identifiers;
receiving, by a receiving device of the processing server, a management request, wherein the management request includes at least a specific lease identifier, a specific managing identifier, and a requesting tenant identifier;
executing, by a querying module of the processing server, a first query on the lease database to identify a specific lease profile where the included lease identifier corresponds to the specific lease identifier;
verifying, by a verification module of the processing server, that the specific managing identifier corresponds to the managing identifier included in the specific lease profile;
executing, by the querying module of the processing server, a second query on the lease database to insert the requesting tenant identifier into the specific lease profile;
receiving, by the receiving device of the processing server, a program request, wherein the program request includes at least the specific lease identifier, the requesting tenant identifier, and program data; and
electronically transmitting, by a transmitting device of the processing server, the program data to a payment card corresponding to one of the plurality of transaction account numbers included in the specific lease profile.

2. The method of claim 1, wherein
each lease profile further includes managing credentials associated with the managing identifier,
the management request further includes authentication credentials, and
verifying that the specific managing identifier corresponds to the managing identifier included in the specific lease profile further includes verifying that the authentication credentials correspond to the managing credentials included in the specific lease profile.

3. The method of claim 1, wherein
the management request further includes tenant credentials,
execution of the second query further inserts the tenant credentials into the specific lease profile,
the program request further includes authentication credentials, and
the authentication credentials correspond to the tenant credentials inserted into the specific lease profile.

4. The method of claim 3, further comprising:
verifying, by the verification module of the processing server, that the authentication credentials correspond to the tenant credentials inserted into the specific lease profile.

5. The method of claim 1, further comprising:
storing, in a memory of the payment card, the program data.

6. The method of claim 5, wherein the memory further includes additional program data associated with one or more additional programs, each additional program being associated with a tenant identifier of the one or more tenant identifiers included in the specific lease profile.

7. The method of claim 1, wherein the payment card includes an embedded integrated circuit.

8. The method of claim 1, wherein the program data includes at least one of: a program identifier, the requesting tenant identifier, a point balance, a plurality of commodity codes, and a plurality of commodity balances.

9. The method of claim 1, wherein execution of the first query on the lease database inserts the specific lease profile as a new lease profile.

10. The method of claim 1, further comprising:
executing, by the querying module of the processing server, a third query on the lease database to insert the program data in the specific profile identifier.

11. A system for managing programs associated with multiple entities on a payment card, comprising:
a transmitting device of a processing server;
a lease database of the processing server configured to store a plurality of lease profiles, wherein each lease profile includes at least a lease identifier, a managing identifier, a plurality of transaction account numbers, and one or more tenant identifiers;
a receiving device of the processing server, a management request, wherein the management request includes at least a specific lease identifier, a specific managing identifier, and a requesting tenant identifier;
a querying module of the processing server configured to execute a first query on the lease database to identify a specific lease profile where the included lease identifier corresponds to the specific lease identifier; and
a verification module of the processing server configured to verify that the specific managing identifier corresponds to the managing identifier included in the specific lease profile, wherein
the querying module of the processing server is further configured to execute a second query on the lease database to insert the requesting tenant identifier into the specific lease profile,
the receiving device of the processing server is further configured to receive a program request, wherein the program request includes at least the specific lease identifier, the requesting tenant identifier, and program data, and
the transmitting device of the processing server is further configured to electronically transmit the program data to a payment card corresponding to one of the plurality of transaction account numbers included in the specific lease profile.

12. The system of claim 11, wherein
each lease profile further includes managing credentials associated with the managing identifier,
the management request further includes authentication credentials, and
verifying that the specific managing identifier corresponds to the managing identifier included in the specific lease profile further includes verifying that the authentication credentials correspond to the managing credentials included in the specific lease profile.

13. The system of claim 11, wherein
the management request further includes tenant credentials,
execution of the second query further inserts the tenant credentials into the specific lease profile,
the program request further includes authentication credentials, and
the authentication credentials correspond to the tenant credentials inserted into the specific lease profile.

14. The system of claim 13, wherein the verification module of the processing server is further configured to verify that the authentication credentials correspond to the tenant credentials inserted into the specific lease profile.

15. The system of claim 11, wherein the payment card includes a memory configured to store the program data.

16. The system of claim 15, wherein the memory further includes additional program data associated with one or more additional programs, each additional program being associated with a tenant identifier of the one or more tenant identifiers included in the specific lease profile.

17. The system of claim 11, wherein the payment card includes an embedded integrated circuit.

18. The system of claim 11, wherein the program data includes at least one of: a program identifier, the requesting tenant identifier, a point balance, a plurality of commodity codes, and a plurality of commodity balances.

19. The system of claim 11, wherein execution of the first query on the lease database inserts the specific lease profile as a new lease profile.

20. The system of claim 11, wherein the querying module of the processing server is further configured to execute a third query on the lease database to insert the program data in the specific profile identifier.
